(19) United States
(12) Patent Application Publication
(10) Pub. No.: US 2002/0087615 A1
(43) Pub. Date: Jul. 4, 2002

(54) Hazardous waste cleaning station

(76) Inventor: Michael J. Hodnick, Crystal, MN (US)

Correspondence Address: Honeywell International Inc., Law Dept. AB2, P. O. Box 2245, 101 Columbia Road, Morristown, NJ, 07962, US

(21) Appl. No.: 09/752,543

(22) Filed: Dec. 28, 2000

(51) Int. Cl. B08B 9/00; G06F 15/16; B08B 9/093; B08B 3/00; B08B 7/04

(52) U.S. Cl. 709/200; 134/18; 134/22.18; 134/166 R

(57) ABSTRACT

A cleaning station is provided which facilitates the cleaning and inspection of a device by allowing the device to be coupled to a fluid source while the device is positioned within a compartment of the cleaning station. Fluid from the fluid source can then be forced through the device to be cleaned, with the fluid flow through the device being observed to determine whether the device is operating properly.

### FIELD OF THE INVENTION

The field of the invention is hazardous waste cleaning stations for inspecting and removing hazardous waste from fluid channeling parts and assemblies.

### BACKGROUND OF THE INVENTION

The use of sinks and other containers in the cleaning of parts is well known. Such “cleaning stations” typically comprise a cavity/sink within which parts may be submerged in or sprayed with water or some other fluid. However, known cleaning stations do not adequately facilitate the inspection of parts/mechanisms used to channel fluids to determine whether fluid flow through the part/mechanism is occurring properly, or whether the cleaning of a clogged part has effectively removed the clog. Thus, there is a need for new and improved hazardous waste cleaning stations.

### SUMMARY OF THE INVENTION

Methods and apparatus are provided which facilitate the inspection and cleaning of parts. In particular, a cleaning station is provided which facilitates the cleaning and inspection of a device by allowing the device to be coupled to a fluid source while the device is positioned within a compartment of the cleaning station. Fluid from the fluid source can then be forced through the device to be cleaned and inspected, with the fluid flow through the device being observed to determine whether the device is operating properly.

In a preferred apparatus embodiment, a cleaning station comprises a sink divided into upper and lower portions via a screen, with a fitting extending into the sink from a position above the screen. The portion of the fitting extending into the sink can be coupled to a device to be inspected and cleaned, and another portion of the fitting is coupled to a fluid source such that fluid from the source may flow through the fitting and into the device being inspected.

In a preferred method embodiment, a manifold comprising a plurality of spray nozzles can be mounted to a fitting extending through a side wall of a cleaning station to allow hands-free inspection of the manifold to determine if any of the nozzles are clogged. Such a determination is made by looking to see whether water forced into the manifold via the fitting sprays out of all of the nozzles. Any clogged nozzle can then be removed, cleaned, re-installed, and then re-inspected by forcing fluid through the device again.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a hazardous waste cleaning station embodying the invention having a part to be cleaned coupled to it;

FIG. 2 is a front view of the cleaning station of FIG. 1.

FIG. 3 is a side view of the cleaning station of FIG. 1.

FIG. 4 is a top view of the cleaning station of FIG. 1.

FIG. 5 is a diagram of a first method of using the station of FIG. 1.

### DETAILED DESCRIPTION

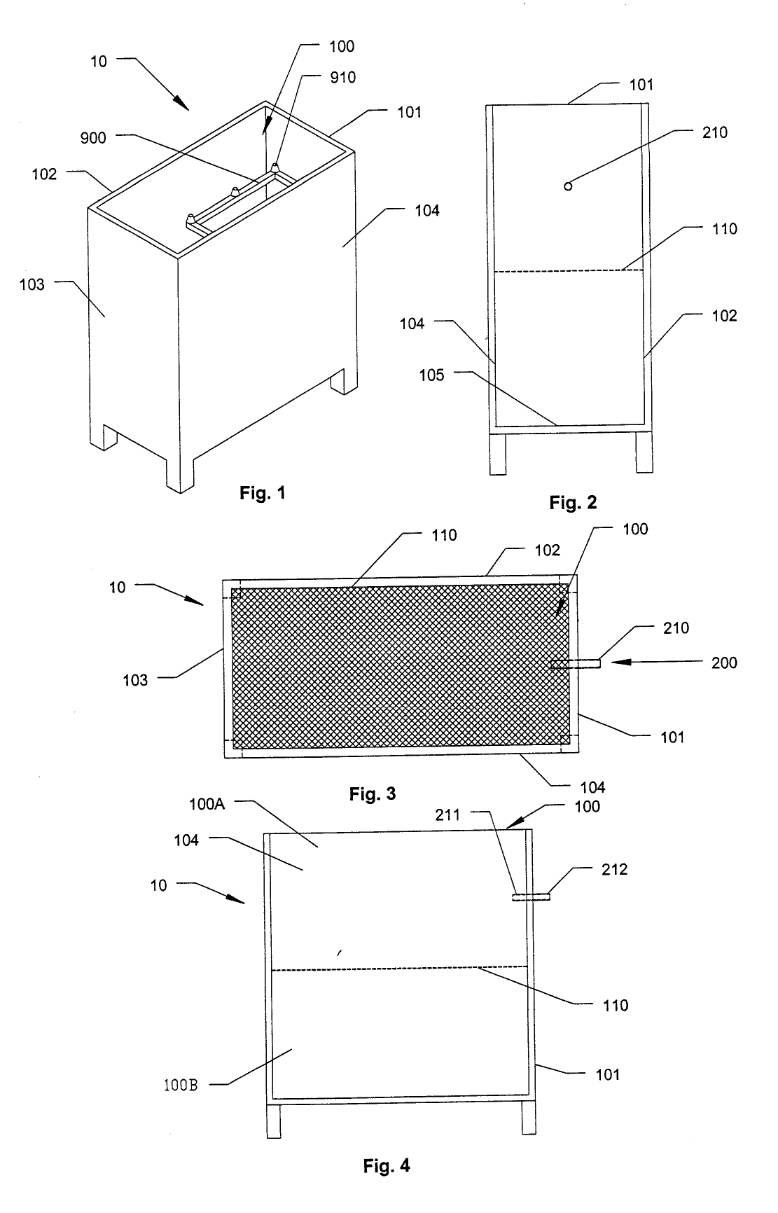

Referring first to FIGS. 1-4, a cleaning station 10 comprises a cleaning compartment 100 and fluid input mechanism 200. Compartment 100 is divided into upper portion 100A and lower portion 100B by strainer 110. Fluid input mechanism 200 preferably comprises a pipe 210 passing through a side 101 of compartment 100 such that it has an interior end 211 extending into upper portion 100A of compartment 100, and an exterior end 212 extending outward from the station 10.

“Hands free” cleaning and/or inspection of a part 900 can be accomplished by coupling part 900 to a fluid source via fluid input mechanism 200. For a part 900 such as a manifold which is designed to used as a fluid conduit, proper operation of the part 900 can be determined by causing fluid from the fluid source to flow through the part 900 via fluid input mechanism 200 and examining the flow through the part 900.

Using fluid input mechanism 200, either by itself or in conjunction with other support mechanisms to support the part 900 allows a person cleaning and/or inspecting the part 900 to utilize both hands for a task other than supporting the part 900. Such “hands free” cleaning and inspection also decreases the risk to personnel as it minimizes the amount of contact, and thus decreases the likelihood of contact with hazardous waste on part 900, during cleaning and inspection.

Station 10 is preferably formed from PVC. The walls of compartment 100 are preferred to be ¼″ thick and to comprise four side walls (101-104) and a bottom (105) to form a rectangular chamber which is open at the top. Station 10 is preferred to have a width of 20 inches, a length of 40 inches, and a height of 45 inches, of which 5 inches is provided by four 2″×2″×5″ legs positioned at the corners of station 10 so as to provide a 5″ gap between the external bottom surface of compartment 100 and any supporting surface upon which station 10 rests. The center of pipe 210 is preferably positioned 10 inches below the top edge of compartment 100 and centered between the side edges of wall 101. Strainer 110 is preferably positioned approximately 20 inches below the top edge of compartment 100 so as to divide compartment 100 into equal upper and lower portions (100A and 100B).

Fluid input mechanism 200 may be any mechanism by which fluid from a fluid source can be channeled through a part to be cleaned or inspected. Fluid input mechanism 200 is preferred to provide adequate support of the part being cleaned such that a part mounted to mechanism 200 need not be supported in any other way during cleaning or inspection. As previously discussed, fluid input mechanism 200 preferably comprises a pipe 210 passing through a side 101 of compartment 100. Pipe 210 is preferred to be made of PVC and to extend into compartment 100 on one end (211), and to extend outward from station 10 on the other (212). End 211 of pipe 210 is preferably sized and dimensioned to mate with the connector of a part to be cleaned. Thus, in some embodiments end 211 may be threaded with threads having a pitch, and the end having a diameter which allows a part 900 to be screwed onto end 211.

In preferred embodiments, fluid input mechanism 200 will facilitate the ability to mount parts which have various size and types of connectors. In one embodiment, pipe 210 may be removably coupled to the station 10 such that, if needed, pipe 10 could be quickly removed and replaced with a pipe having a different diameter or a different mechanism for allowing a part to be coupled to it. It is contemplated that having station 10 comprise a rack or container for holding alternate fittings 210 may be beneficial in embodiments in which multiple pipes or other fittings 210 are used to allow fluid input mechanism 200 to be adapted to different parts to be cleaned.

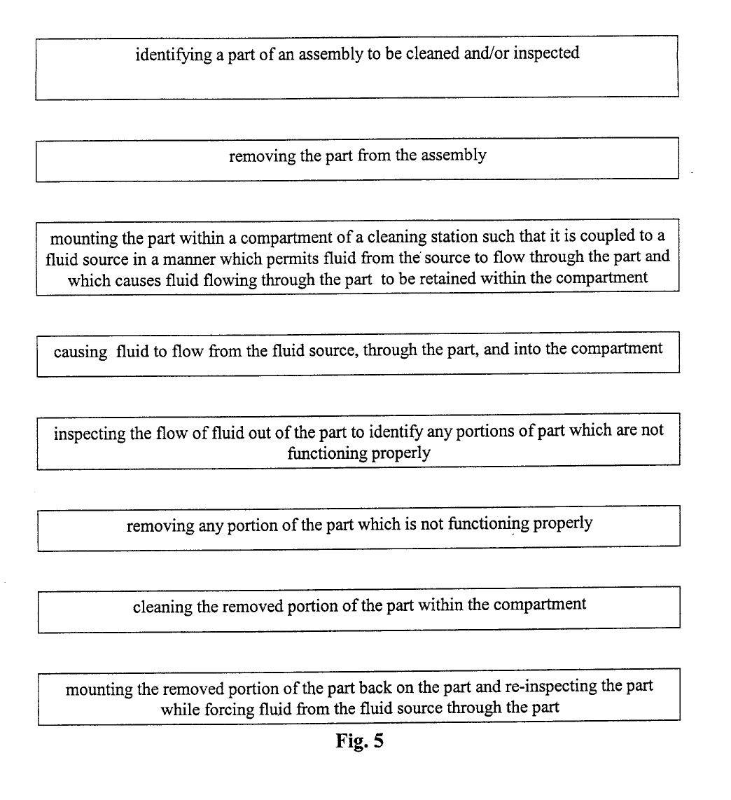

Referring to FIG. 5, a preferred method of using cleaning station 10 to clean a part/mechanism 900 comprises: removing the part from the assembly; mounting the part 900 within a compartment 100 of a cleaning station 10 such that it is coupled to a fluid source in a manner which permits fluid from the source to flow through the part 900; causing fluid to flow from the fluid source, through the pipe/fitting 210, through the part 900, and into the compartment 100; inspecting the flow of fluid out of the part 900 to identify any portions (such as nozzles 910) of part 900 which are not functioning properly.

If the part/mechanism 900 to be cleaned and inspected comprises a plurality of nozzles 910 through which the fluid from the fluid source will flow if the nozzles are not clogged, the method may further include: removing any nozzle 910 identified as a portion of the part 900 which is not functioning properly; cleaning the nozzle 910 within the compartment 100; mounting the nozzle 910 back on the part 900; re-inspecting the nozzle 910 while forcing fluid from the fluid source through the part 900.

It is contemplated that alternative embodiments may include an electric pump for pumping waste out of the cleaning station. Such a pump may be advantageously used in conjunction with a local holding tank and/or waste treatment facility to transfer waste directly from the station to such a tank or facility. Alternatively, such a pump could facilitate transfer of waste from the station to a waste disposal container to be used to transfer the waste to another location.

Another contemplated embodiment would utilize a waste disposal container such as a drum as part of or in conjunction with the cleaning station. One such embodiment would be to have the station mounted on top of a drum such that the compartment 100 drains directly into the drum. Such an embodiment may have a compartment 100 which is only one half as high as other embodiments, with the strainer 110 being positioned at the bottom of the compartment and adjacent to the top of the drum.

Thus, specific embodiments and applications of hazardous waste cleaning stations have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of cleaning a device which is part of an assembly comprising:
providing a cleaning station;
removing the device from the assembly;
mounting the device within a compartment of the cleaning station such that it is coupled to a fluid source in a manner which permits fluid from the source to flow through the device, and any fluid flowing from the fluid source through the device is retained within the compartment;
causing fluid to flow from the fluid source, through the device, and into the compartment; and
inspecting the flow of fluid out of the device to identify any portions of the device which are not functioning properly.

2. The method of claim 1 wherein the device comprises a plurality of nozzles through which the fluid from the fluid source will flow if the nozzles are not clogged, the method further comprising:
removing any nozzle identified as a portion of the part which is not functioning properly;
cleaning the nozzle within the compartment;
mounting the nozzle back on the part; and
re-inspecting the nozzle while forcing fluid from the fluid source through the part.

3. An combination comprising:
an combination to be cleaned and inspected;
a cleaning station having a compartment and a fluid input mechanism coupled to a fluid source, the fluid input mechanism extending into the compartment;
wherein the combination to be cleaned is coupled within the compartment to the fluid input mechanism such that fluid flowing from the fluid source and through the fluid input mechanism will flow through the combination to be cleaned.

4. The combination of claim 3 wherein the compartment is characterizable as having a length and width, and the compartment is divided into upper and lower portions by a strainer, the strainer extending across the entire length and width of the compartment.

5. The combination of claim 3 wherein the fluid input mechanism comprises a pipe extending through a side of wall of the compartment, the pipe having a threaded interior end to which the assembly to be clean is coupled, the interior end extending into the compartment, and an exterior end to which the fluid source is coupled, the exterior end extending outward from the cleaning station.
